(19) United States
(12) Patent Application Publication
(10) Pub. No.: US 2008/0235263 A1
(43) Pub. Date: Sep. 25, 2008

(54) Automating Creation of Digital Test Materials

(75) Inventors: Ulmar Riaz, Webster, NY (US); Peter G. Anderson, Pittsford, NY (US)

Correspondence Address: Stephen B. Salai, Esq.;Harter, Secrest & Emery LLP, 1600 Bausch & Lomb Place, Rochester, NY, 14604-2711, US

(73) Assignee: ADI, LLC, Rochester, NY (US)

(21) Appl. No.: 12/040,896

(22) Filed: Mar. 2, 2008

Related U.S. Application Data
(60) Provisional application No. 60/892,659, filed on Mar. 2, 2007.

(51) Int. Cl. G06F 17/30

(52) U.S. Cl. 707/102; 707/E17.044

(57) ABSTRACT

A system and method for automatically creating a digital test materials to qualify and test forms processing systems, including preparing a handprint snippet database containing labeled handprint image snippets representing a unique human hand, preparing a form description file and a data content file, selecting handprint snippets from the handprint snippet data base to formulate a form using the data content file, creating a form image using the selected snippets according to the form description file, and, if desired, printing the form image.

### CROSS-REFERENCE TO RELATED APPLICATIONS

This application claims the benefit of U.S. Provisional Application No. 60/892,659, filed Mar. 2, 2007, which application is hereby incorporated by reference.

### TECHNICAL FIELD

The invention is related to the fields of image processing, document image formats, and variable data printing in general, and PostScript and forms processing data capture in particular.

### BACKGROUND OF THE INVENTION

This invention further develops an earlier invention disclosed in U.S. patent application Ser. No. 10/933,002 for a HANDPRINT RECOGNITION TEST DECK”, filed Sep. 2, 2004, which application is hereby incorporated by reference. The application, which published under number 2006/0045344 A1 on Mar. 2, 2006, describes a system and method for creating test materials such as a Digital Test Deck® available from ADI, LLC of Rochester, N.Y., which include either the images or prints of synthetic forms that realistically appear to be actual forms filled out by human respondents. Using such images and/or prints, one can cost-effectively test and evaluate forms processing data capture systems for accuracy and efficiency, because the truth of the data placed on these test decks is known perfectly.

The improvements made by the present invention allow one to more easily and quickly create such Digital Test Decks® through the use of computer automation. This is important as these decks are used to efficiently and cost-effectively test and evaluate data capture in forms processing systems, which may include Key From Paper (KFP), Key From Image (KFI), Optical Character Recognition (OCR), Optical Mark Recognition (OMR), or all of the above.

### SUMMARY OF THE INVENTION

A new process implementable using a computer program called “AutoDTD” was developed to streamline the creation of test decks, such as a Digital Test Deck® (DTD), and to produce large and complex test decks in a simple and efficient way. There are two different versions of the AutoDTD. The first incorporates tiff-type formatting (e.g., Tagged Image File Format from Adobe Systems) and creates DTD forms as raster images by putting the hand character snippets on the blank DTD form image. This is primarily useful for generating electronic test decks that may be used to test software subsystems, without involving scanners. The second incorporates PostScript-type page description language, as is also available from Adobe Systems, in which the hand character snippets are put on the PostScript document using, for instance, the PostScript imagemask command. This version produces very high quality images suitable for printing by a digital color press. A significant advantage of the AutoDTD process is that it is quick, easy to use, less error prone and can produce very large digital test decks in a short time.

There are many advantageous aspects of using the AutoDTD process described herein, including:
1) The AutoDTD process is fast, needs few manual steps to perform, and, hence, requires much less effort than more labor-intensive approaches.
2) There is no limit on the size of the Digital Test Deck that can be created. Complex, large decks (e.g., 10,000 or more forms) can be produced automatically with very little manual effort.
3) As most of the process is automated, it is less prone to errors. If all the inputs are correct, like the form definition file, DTD data file, and the HCDC dictionaries, then there is almost no chance of an error. This is very important, because errors in the input “truth” will result in errors in testing and subsequent scoring of the data capture system, which defeats the purpose of the system.
4) It takes even less time to create similar decks. Since it takes very little time to produce a deck once all the inputs are ready, so another deck with slight modifications can be produced very quickly.
5) The tiff version, being a raster format, can simulate images that may have come from a scanner. This is useful when software-only tests are appropriate, as in testing a recognition sub-system like OCR or OMR or Key From Image staff, and printed forms are not needed.
6) The PostScript deck is good for printing, generally having better print quality than using tiff images.
7) The process works with any resolution (usually expressed in dots per inch, or dpi) of Handprint Character Database Collection (HCDC) snippets without making any change. It automatically reads the dpi value from snippets and then scales them appropriately on the form. Snippets of different resolutions can be used in the same form or deck.
8) One can put barcodes directly in the PostScript format on the DTD forms. There is no need to convert them into raster format before using them, giving smaller files and higher image quality.
9) The process can automatically verify the HCDC database and only uses hands (a collection of characters from a single respondent) that are complete. This eliminates any possibility of error because of incomplete hands.
10) There is no need to create fixed size HCDC snippets. Any size can be used.
11) The process can work with gray scale or color HCDC snippets, in addition to bi-tonal snippets.
12) Raster image file decks can also be produced from the PostScript deck using programs like Photoshop™ or ImageMagick™. It can also serve as a deck of scanned images that can be fed directly to a recognition system. If a test deck is needed only to test the recognition or keying process (and not the scanning process) then this electronic deck can serve the need and no real paper deck may be necessary.
13) One can easily specify pen ink color (including pencil) for each DTD form through the database file.
14) Hand printed character snippets can be morphed (stretched, skewed, rotated, etc.) to realistically vary the handprint.
15) One can use random or specific hand selection for each DTD form through the database file.
16) One can use the Auto Output filename convention scheme or specify output file names through the database file.
17) AutoDTD creates field maps along with the Digital Test Deck® to facilitate forms processing.
18) No separate process is needed to create a Truth file, since the input DTD data is the real Truth (if no special characters are defined in the data file to put special marks on check-box fields).
19) AutoDTD generates a Report/Log file at the end to report a summary of the completed process, random selections, and/or any errors.
20) Although the file size of each document is very small, still there is a lot of redundant information in the background of each form. This can be solved by creating fat PostScript (containing one copy of the original form and PostScript code to put character snippets on the multiple forms) or by using variable data printing technology.

### BRIEF DESCRIPTION OF THE DRAWING FIGURES

FIG. 1 is a block diagram of the PostScript/PDF version of the AutoDTD process.

FIG. 2 is a flow chart of the DTD creation process.

FIG. 3 is a screen image of the FormView application displaying a form and allowing a user to define field coordinates and other properties.

FIG. 4 (a) shows a form definition file for a given form (XML schema).

FIG. 4 (b) shows a form definition file for a given form (tab delimited text format).

FIG. 5 depicts a Handprint Character Database Collection (HCDC) sample.

FIG. 6 is a block diagram of a DTD data generator.

FIG. 7 (a) is a screen image of a Barcode Creator application dialog box.

FIG. 7 (b) shows PostScript code for creating barcodes.

FIG. 8 is a screen image of a DTD creation setup dialog box.

FIG. 9 is a screen image of a Field Map Creator dialog box.

### DETAILED DESCRIPTION OF THE INVENTION

This description primarily discusses the PostScript version of the AutoDTD process; however, most discussion applies also to the tiff version.

There are five input items that are needed to create a DTD using the AutoDTD method. Clients could provide some of them, but most of them can be created very efficiently using AutoDTD tools or components. Following is the list of inputs that are needed for the AutoDTD process:
1. Background form (in PDF or postscript format),
2. Form definition file (contains field coordinates and properties),
3. DTD data (the data that is to be put on the DTD in the form of hand written characters),
4. Handprint Character Database Collection (HCDC), and
5. Barcode creation (in postscript format, needed only if there are any variable barcodes on the form).

Item 1 is the background form, which is preferably provided by the client in the PDF or PostScript format. This PDF form document is then loaded into the FormView application to create the form template or the form definition file.

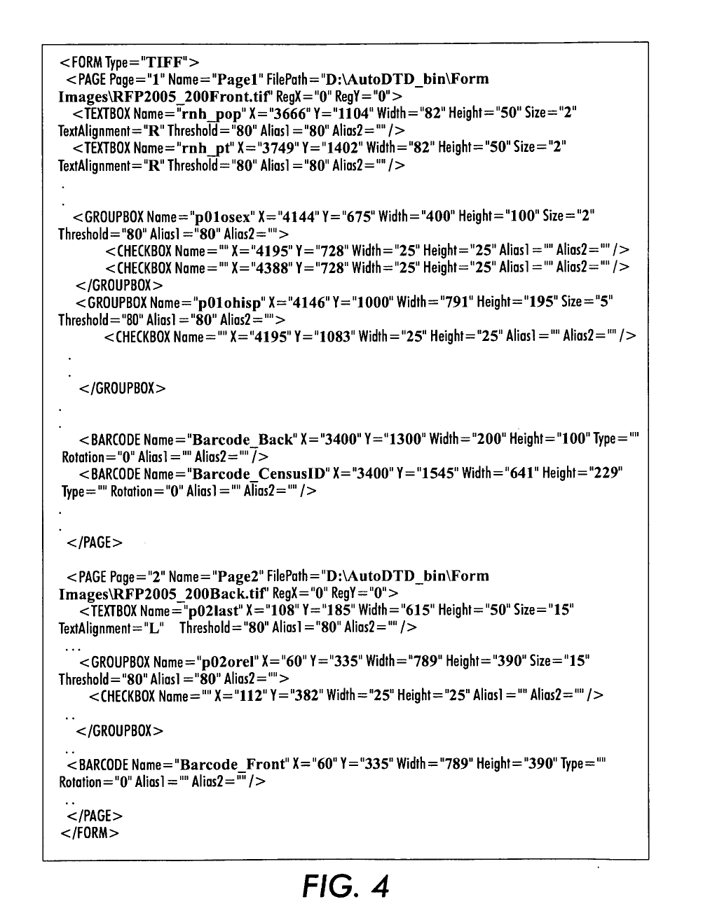

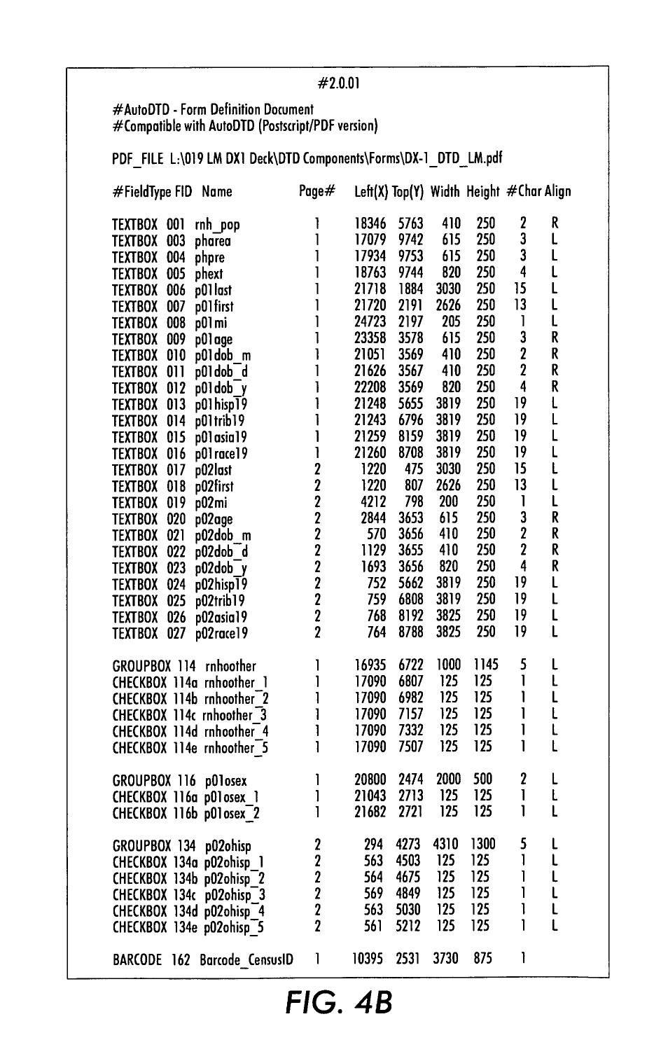

Item 2, the form definition file contains information about the type (such as textbox, checkbox, or barcode), location, and size of the fields (see FIG. 4) on the DTD form where the hand-written characters are to be placed. FormView is a versatile form definition tool that provides a Graphical User Interface (GUI) to build the form template. More details about the FormView application are given below.

Item 3 is the DTD data file that contains all the data in a database table that is to be put on the DTD forms (preferably in XML format). Each field in the table corresponds to a field on the DTD form as defined in the form definition file and each record corresponds to a form in the DTD. If the size of the DTD is not very large, then the data could be produced manually, otherwise it could be generated using the data generator program. The data generator program creates DTD data for forms in an automated way. Data is generated by randomly picking data from field data dictionaries and frequency tables using some rules. But since every form is different from another, it has different fields and properties and these have different relationships among each other. As such, these programs are preferably modified each time to produce data for a new form. However, in this description, we show some aspects of a more generic DTD Data Generator program that can be tuned or optimized to produce data for any or most of the DTD forms.

Item 4 is the Handprint Character Database Collection (HCDC), which is basically a collection of various “hands”; character snippets collected from the handwriting of different persons. A hand is a collection of hand snippets comprised of all the characters required to populate the fields on a form, with multiples of each character (typically A-Z, a-z and 0-9) collected from the handwriting of a single person. The HCDC is collection of bitonal or grayscale snippets but a color can be given to hand characters if specified in the DTD data file. A separate set of tools and mechanisms can be used to collect these hands and archive them in a HCDC database. The HCDC is not collected or modified each time a DTD is created unless there are very special characters needed to put on the forms that are not available in the collection.

Item 5 is barcode creation. If there are any variable barcodes to be put on the DTD forms, then they all should be created before running the DTD creation process. The barcodes are arranged in the postscript format and can be applied “as is” on the DTD form document at the location provided by the form definition file. The Barcode Creator component of the AutoDTD system helps create these barcodes. This item discusses barcodes, but also contemplates other data forms such as special logos, icons, or data created from a static or variable data process. Typically, these are created in a batch process and presented to AutoDTD as images to be inserted onto the background form. Other examples include Magnetic Ink Character Recognition (MICR) fonts and various background images for simulated test decks for bank checks.

If these items are available or prepared, then a very large, complex DTD can be created in a short time using the AutoDTD program with minimal human intervention. A Digital Test Deck® form can be created by putting handprint character snippets (as given in the data file) at the desired location (as defined in the form definition file) on the postscript form document. The AutoDTD process begins operation by loading and verifying: the data file (Item 3), the file path location of the HCDC (Item 4); the background Postscript or encapsulated Postscript file (Item 1); and the form definition file (Item 2).

As preferably arranged, AutoDTD first establishes the form image as a PostScript “form” to be cached and subsequently used with PostScript's execform directive. In case of front-and-back or multi-page forms, more such images will be loaded and processed. This form caching results in leaner eventual PostScript or PDF documents.

During the preferred generation process, the AutoDTD generator randomly picks and loads a hand from the HCDC database. Then, the generator chooses a hand snippet (of the character as specified in the DTD data), converts the data into hexadecimal PNG format, and puts it at the field location as specified in the form definition file. The generator repeats the same step until all the characters on all the fields are filled. The generator repeats the same step to place check marks, barcodes, or any other special marks. When the whole page is filled out, the generator saves the postscript document in the output directory. The generator repeats the same process for all the pages in the form, and then, the generator prepares for the next DTD form and repeats all the above steps until the whole test deck is complete.

Each hand contains several instances of each letter, digit, punctuation, or special character captured from a single writer (or several similar writers). To create realistic filled-in forms, AutoDTD randomly selects varying instances for each desired character, and applies, if desired, a specified amount of morphing to each selected character (morphing includes, but is not limited to, changes in position, slant, rotation, size, etc.).

The description of the PostScript code that puts the hand character snippets on the form is given below. The code has three main portions: the definition of hand character snippets as a bi-level bitmap expressed in a hexadecimal format, here PNG; the function that scales and puts these characters in the desired location; and finally calling and passing the required parameters for the function that scales these characters. Following is a brief description of each of these pieces of code:

### 1. Hand Character Snippet Definition:

The raster of all the hand character snippets used in the form are defined in the hexadecimal PNG format. These snippets are used by the Postscript imagemask in the ShowChar function; ‘0’ means a black (or other specified color) pixel and ‘1’ means nothing or a transparent pixel. Not all the snippets from a hand are defined; instead only those are used in the form are defined in order to minimize the size of the output file.

%% Definition of the HCDC Character Snippets used in the form in PNG format.
/a_762 <
FFFFFFFFFF FFFFFE1FFF FFFFF81FFF FFFFE01FFF FFFFE01FFF FFFFC3FFFF FFFF87CFFF
FFFF8FC7FF FFFF8FC7FF FFFF1FC7FF FFFF1FC3FF FFFF0F01FF FFFF8021FF FFFF8070FF
FFFFE1F87F FFFFFFFC3F FFFFFFFE3F FFFFFFFFFF FFFFFFFFFF FFFFFFFFFF FFFFFFFFFF
> def
/n_6338 <
FFFFFFFFFF FFFFF1FFFF FFFFE0FFFF FFFFC07FFF FFFF807FFF FFFF003FFF FFFE0E3FFF
FFFE1E1FFF FFFE1F0FFF FFFE3F0FFF FFFE3F87FF FFFE3F87FF FFFE3FC3FF FFFE3FC3FF
FFFE3FFFFF FFFFFFFFFF FFFFFFFFFF FFFFFFFFFF FFFFFFFFFF FFFFFFFFFF FFFFFFFFFF
> def
/N_9662 <
FFFFFFFFFF FFFFFFFFFF FFFF8FFF1F FFFF8FFF1F FFFF87FF0F FFFFC7FF8F FFFFC7FF87
FFFFC7FFC7 FFFF83FFC7 FFFF83FFC7 FFFF01FFC7 FFFF01FFC7 FFFF01FFC7 FFFF08FFC7
FFFF88FFC7 FFFF807FC7 FFFF843FC7 FFFF861F87 FFFF860F8F FFFF87078F FFFFC7830F
FFFFC7C01F FFFFC7E01F FFFFC7F87F FFFFFFFFFF FFFFFFFFFF FFFFFFFFFF FFFFFFFFFF
> def
.
.
.

### 2. ShowChar Function:

This is the main function that can be called each time a form is created to put hand character snippets on the form. The ShowChar function is parameter driven, accepting the hand to be used, the snippet resolution, and snippet location on the form. As shown here, ShowChar takes seven parameters (in PostScript, seven values supplied on the stack): character coordinate position (2 parameters), character snippet dimensions (2 parameters), character snippet resolution (2 parameters), and the name of the snippet bitmap (one parameter).

The form of ShowChar shown here is just one instance of it. Other manifestations include the use of random numbers for morphing and controlling other variations such as the degree of “sloppiness” of the form's hand print.

%% ShowChar function: to put character snippets on the form.
/inch {72 mul} def
/ShowChar {

| gsave | |
|---|---|
| /character exch def | % Raster of the snippet in hex PNG format |
| /ResoY exch def | % dpi resolution of the character snippet |
| /ResoX exch def | % dpi resolution of the character snippet |
| /H exch def | % Height of the character snippet |
| /W exch def | % Width of the character snippet |
| /Y exch def | % Location of the character snippet along Y |
| | axis |
| /X exch def | % Location of the character snippet along X |

axis

X inch Y inch add translate
W ResoX div inch H ResoX div inch scale
W H false
[W 0 0 H 0 0]
character
imagemask
grestore

} def

select the instance of each individual letter, determine its size and resolution, and, finally, apply the actions of ShowChar.

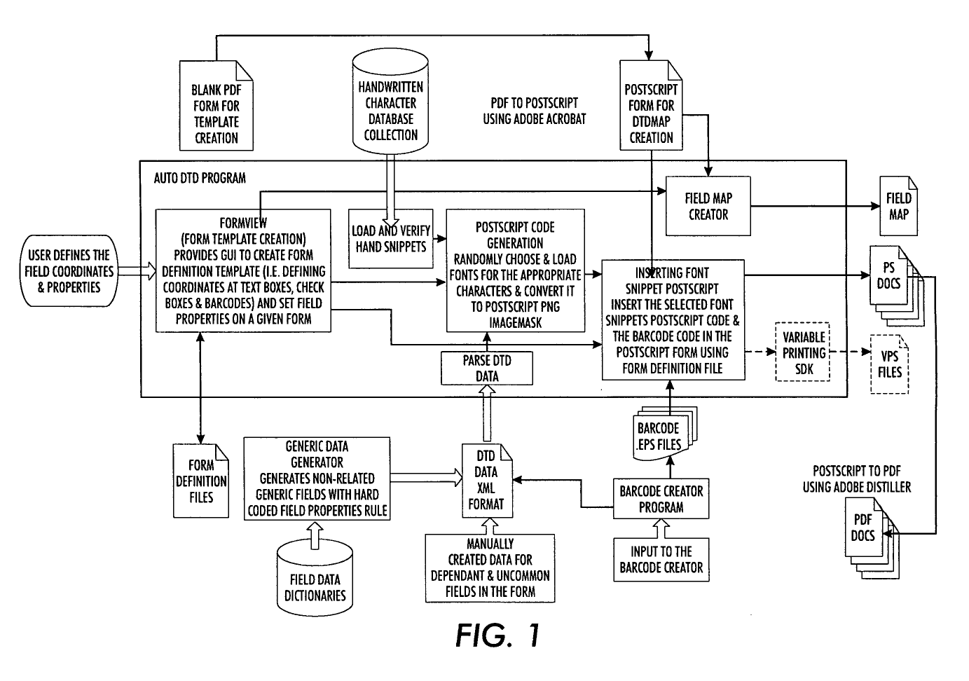

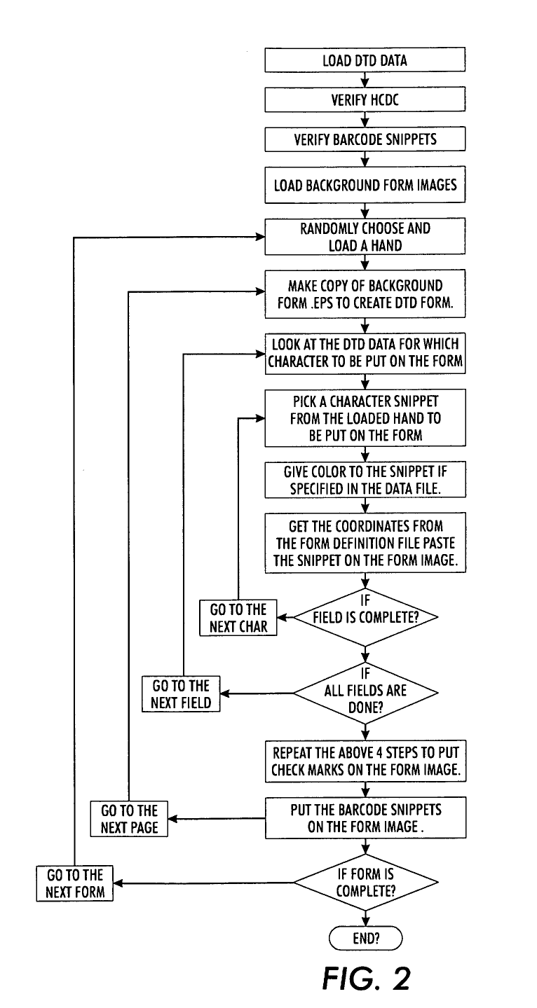

The block diagram of the AutoDTD process is given in FIG. 1, and a flow chart is shown in FIG. 2.

### Tools & Components:

AutoDTD has many components: FormView, data generator, barcode creator, HCDC, and the main DTD creator program. Some of these components are implemented within the main AutoDTD application, others are separate applications, and others are imbedded within the resulting PostScript document itself. These are all essential tools for DTD generation. Following is the brief description of each of these components:

### 1) FormView Application:

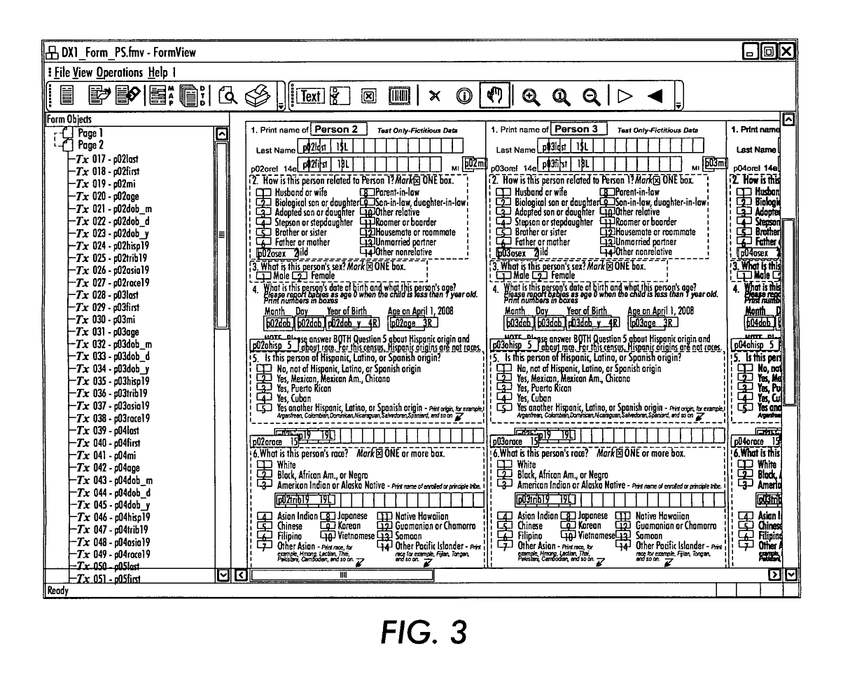

FormView is a versatile form definition tool that provides a Graphical User Interface (GUI) to build a form definition file (also known as the form template) of any given form (see FIG. 4). The form definition file contains the location coordinates and other information of the different fields on the form (like textboxes, group & check boxes and barcode boxes) where the handwritten characters are to be put. The format of the form template is preferably XML or the human readable tab delimited text. The format of the files is also preferably XML or the human readable tab delimited text file (see FIGS. 4a & b). To create the form definition file, first the PDF document of the DTD form can be loaded into FormView, which displays the document on the screen and allows the user to define field coordinates and other properties. The application provides a user interface to set or modify field properties. The coordinates of the fields can be defined by drawing boxes on the screen over the form using the mouse. The application builds a list for the fields grouped in each page on a panel shown on the left size of the application window (see FIG. 3). This helps the user to navigate to different fields or pages on the form. Double clicking on a field box or an item on the field panel displays a dialog box, where the properties of that field can be set. FormView also preferably has very convenient user interface features to add, modifying, delete, copy, resize, or move any existing field on the form. The form definition file gives AutoDTD the information about type, location, dimension, size, and some other properties of a field.

FormView is one of several possible methods to provide field coordinate information for a form. Other methods are programmatic extraction of coordinates from a form's PostScript, image processing via Hough transform, etc.

### 2) Handprint Character Database Collection:

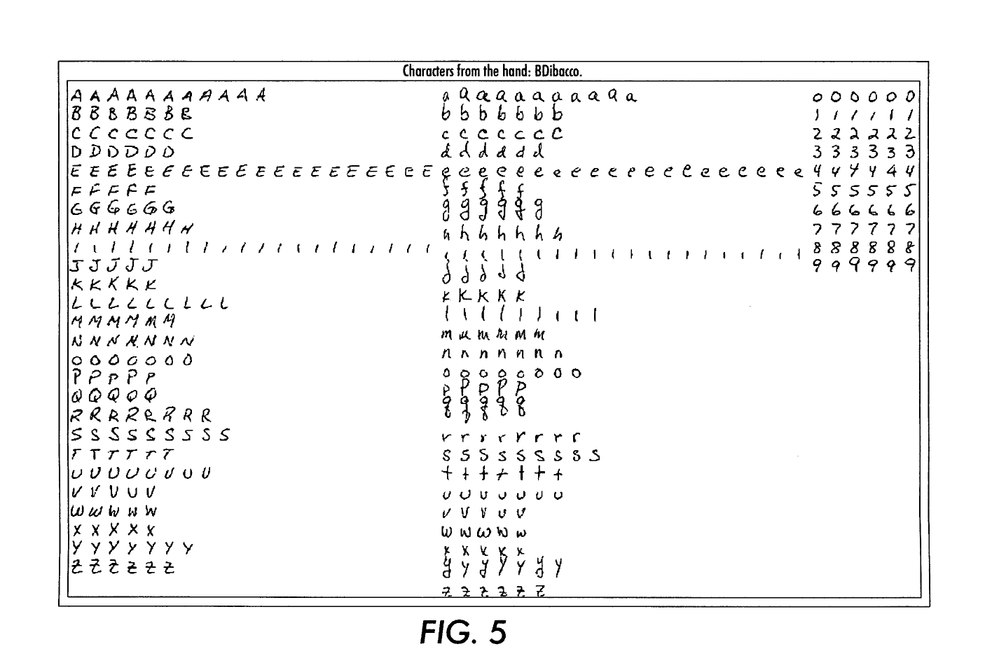

The Handprint Character Database Collection (HCDC), a major component of the Digital Test Deck®, can be organized into a set of “hands” (see FIG. 5). A single hand is a collection of various handprint character snippets collected from the handwriting of one person. A hand comprises all the characters required to populate the fields on a form, with several instances of each character (typically A-Z, a-z and 0-9) collected from the handwriting of a single person. In addition to the typical characters, other special characters and marks, such as the cross marks and checkmarks, are also preferably collected. This provides the building blocks to form the data fields required for any and all fields that are required to complete the form.

It is a well-known fact that when someone writes longhand, the size, shape, and various other characteristics of a single character (e.g., an ‘a’) will vary in random ways with each usage. And it is also well known that one person's longhand can be significantly different form another's. Thus, a ‘hand’ is one person's characters captured multiple times.

The HCDC, a collection of hands, provides the variability and realism that cannot be found if one were to use a ‘font’ (which contains a single sample of each character). This is partly because most fonts are “too neat” and would thus give an artificially high estimate of recognition or keying accuracy relative to the “real world.” Using the HCDC to complete the average form, gives it the “look-and-feel” of having been actually completed by a person with realistic variability in handprint. A human looking at these simulated forms cannot tell they are not real forms filled out by real respondents; nor can a scanner.

The HCDC is a very large collection of hands that have been verified to be labeled correctly (Truthed), but which are challenging, with varying degrees of difficulty, to forms recognition systems. It also is a large, statistically significant collection, which models the universe of hands that typically fill in forms from the population in general. Methodologies were employed to collect the hands using collection and rendering tools that ensured that all hands and all characters within a hand are labeled correctly and added to the DTD database to facilitate their usage.

### 3) DTD Data Generator:

To create a Digital Test Deck®, data is required that is to be put on the forms. The data can be created manually if the deck is small, but for large test decks, there must be an automated method to create that data. The Data Generator is a program that creates such data for any given DTD forms in an automated way. Data is generated using the field data dictionaries, frequency tables, and some rules. The generator preferably outputs the DTD data as XML format. MS Access and tab-delimited text formats are also available, which can be later loaded into the AutoDTD program to produce a DTD. Each field in the table corresponds to a field on the DTD form as defined in the form definition file, and each record corresponds to a form in the DTD.

Random or unrealistic data cannot be put on the DTD forms because such data could confuse any context checking used by the OCR/OMR system you are trying to test, producing unrealistic or misleading test results. The DTD data must be realistic, not only to make the test deck look more realistic, but also to thoroughly and properly test an OCR/OMR system and its incorporated logic. The generic Data Generator is an automated way to create such data for DTD forms.

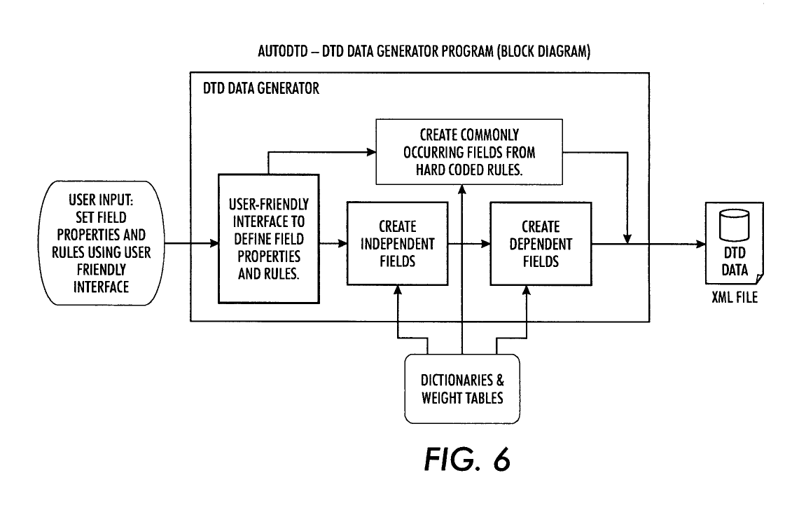

Referring to FIG. 6, the DTD data is generated using some dictionaries, frequency tables, and rules. Many fields, e.g., First Name, Last Name, Date of birth, phone number, Address, etc., are commonly occurring, as you will find them on most forms. So their dictionaries and rules can be hard coded in the program for anytime use. But there will often be some fields in a form that are not very common and are not hard coded in the program. A user can define these fields with their rules and create dictionaries or frequency tables for them. The data dictionaries and frequency table are text files and have a specific format for so they can be defined anytime for any new field, but defining a new rule is a more complex process. Like commonly occurring fields, commonly occurring rules will also be hard coded in the program. A user would pick one of these predefined rules or create new rules by a combination of other rules.

There are two kinds of fields in DTD forms: the independent and the dependent fields. The independent fields are ones that are chosen from a given dictionary or frequency table (that contains what percentage of each output to be chosen, mainly used for OMR fields) using some simple rules and are not dependent upon the output of other fields. The dependent fields are one that are chosen from dictionaries or frequency tables using some rules based on the output of other field (e.g., children should be younger than their parents). Independent fields can easily be created by defining a dictionary or frequency table and a simple method to pick data, but dependent fields are generally created from dictionaries using some rules defined by a user. The concept of the generic Data Generator program is to provide a GUI to input these rules in a very simple way. Any fields that cannot be generated easily using the Generic Data Generator (because of the complexity of rule or unavailability of dictionaries) are generated manually.

### 4) Barcode Creator:

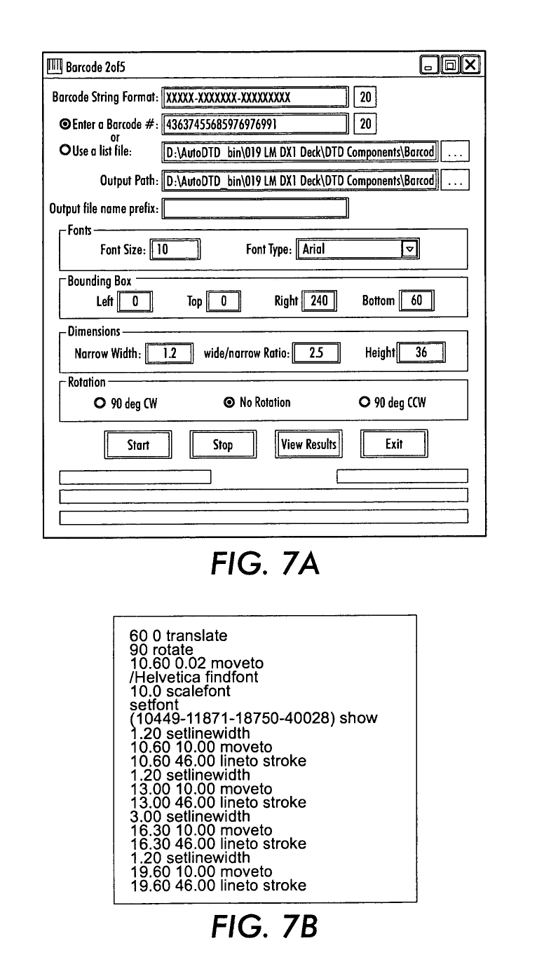

Referring to FIG. 7, the Barcode Creator is separate program but it is one of the AutoDTD components. It creates barcodes in the PostScript/eps format that are to be put on the form. The creator also allows the user to set dimensions, rotation, thickness, fonts, and bounding box of the barcodes. The creator allows the user to create a single barcode by inputting the number and the format string or it can create multiple barcodes by inputting a barcode number list file. All the variable barcodes that are to be put on the forms must be created beforehand, and are then supplied to the AutoDTD program to put them on the desired location (as defined in the coordinate file) on the DTD forms.

### 5) DTD Creator:

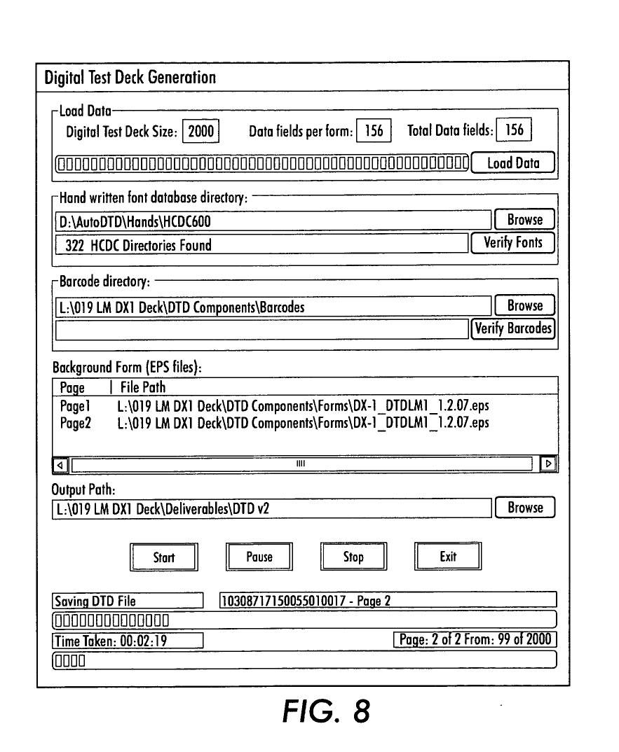

Referring to FIG. 8, the DTD Creator is a main component of the AutoDTD system that actually performs the operation of creating the Digital Test Deck® after collecting inputs from all other components. It is implemented inside the main AutoDTD program, which also comprises FormView and the Field Map Creator components. The creator also creates field maps, which are basically a DTD form that has field coordinate boxes, field names and some other properties rendered over them. This is also useful for setting up the data capture system under test to process the Digital Test Deck®.

### 6) Field Map Creator:

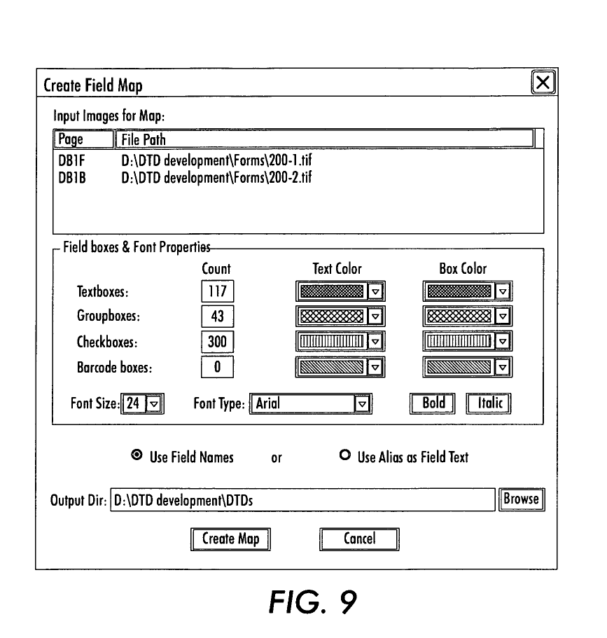

Referring to FIG. 9, the Field Map is generally a DTD form that has field coordinate boxes, field names, and some other properties rendered over them. The map is one of the outputs that can be used by clients to setup their data capture system. Like DTD Creator, the FieldMap Creator is implemented inside the main AutoDTD program, which also comprises DTD Creator.

### DTD Creation Steps:

The following steps can be used to create a Digital Test Deck® (see FIG. 2).

### 1) Form Definition Template Creation:

Usually, the first step is to create a form template also known as the form definition file. The FormView application provides convenient user interface features to add, modify, delete, copy, resize, or move any existing field on the form. The form definition file gives AutoDTD the information about type, location, dimension, size, and some other properties of a field. The fields (where the handwritten characters are to be placed) on the form can be defined by manually drawing the boxes and for each field, setting up its field name, coordinates, and other properties. The format of the form template can be XML, or alternatively a human readable tab-delimited text.

### 2) Data Generation:

The data file (the DTD data that is to be put on the forms) can be created either manually (if the DTD size is not very large) or by using the Data Generator program. The program makes sure that the data is correct (exactly what you want on the forms), has all the fields that are defined in the form definition file, and has the correct field names. This is important to associate the data with the fields properly. Missing fields or a mismatch in field names will result in an error message in the DTD creation step.

### 3) Setting Up Color, Hand and Output File Names:

These aspects for any specific form can be specified by providing data in the following fields in the DTD data file:

### 3. Calling the ShowChar Function:

The ShowChar function can be called to put the snippets on the form. The parameters such as raster, location, size, and resolution of the hand snippets are passed to the ShowChar function to fill out the blank postscript form with hand characters. The location of each character is computed from the coordinates of each field given in the form definition file, whereas size and resolution of the snippets is given in tiff header.

%% Calling the ShowChar function to put characters on the form.
0 0 0 0.45 setcmykcolor % defines CMYK color value of the hand
snippets
1.170 0.990 40 130 200 200 S_6145 ShowChar
1.371 0.990 40 130 200 200 t_5927 ShowChar
1.572 0.990 40 130 200 200 e_7104 ShowChar
5.560 0.985 40 130 200 200 L_5096 ShowChar
5.761 0.985 40 130 200 200 a_3519 ShowChar
5.962 0.985 40 130 200 200 b_5554 ShowChar
6.163 0.985 40 130 200 200 r_1977 ShowChar
6.364 0.985 40 130 200 200 o_7623 ShowChar
6.565 0.985 40 130 200 200 s_5015 ShowChar
6.766 0.985 40 130 200 200 a_9898 ShowChar
.
.
.

An example of an alternative formulation would be an invocation, as follows:
1.170 0.990 0.201 (SteLabrossa) ShowField

In this case, the ShowField routine only needs a field's starting location (parameters 1 & 2), the width of each character in the field (parameter 3), and the character string used. Then, ShowField can randomly
a) FieldID: In this field goes the name of output files. The field also serves as a database table key. If this field is not present or blank, then the program uses its own default naming scheme.
b) Color: This field provides the CMYK color value of the hand characters. If it is not present or blank, the program uses black as a default.
c) Hand: This specifies which hand is to be used from HCDC to fill out the DTD form. If this field is not present or blank then the program randomly chooses a hand from the HCDC.
   4) Barcode Creation (if any):

If there are any variable barcodes to be put on the DTD forms then they are all preferably created as encapsulated PostScript files before running the DTD creation process. The Barcode Creator program helps create these barcodes. A barcode number list file is also preferably created and loaded into the barcode creator program to create all the barcodes in a single step. The user can thereby set properties like dimensions, rotation, thickness, fonts, and bounding box of the barcodes appropriately.

### 5) Setting Up DTD Creation Process:

Once all the above inputs are ready, the AutoDTD application can be run and the form definition file can be loaded. The file loads the PDF form document and lists down and draws field boxes on the screen. Clicking the DTD button causes a DTD generation dialog box to appear as shown in FIG. 8. Instructions for setting up DTD creation process follow:
a) Load and Verify DTD data: Click the Load Data button on the DTD generation dialog box to load the DTD data from, say, XML or a MS Access file. The program verifies that data for all the fields specified in the form definition file are loaded properly. The names of the fields in the database file must exactly match with the names of the fields in the form definition file to associate the data with the fields properly.
b) Load and Verify HCDC (Handprint Character Database Collection) snippets: Set the path of the hand directories and then click ‘Verify Fonts’ button. This process verifies that all the HDDC directories are complete. Then, the process makes a list of them for future random selection of hands. The dpi resolution of the hand font snippets should be same as of the background form images.
c) Load and Verify barcodes snippets: Perform this step if there are any barcodes in the form. Set the path of barcode directory and click ‘Verify Barcode’ button. This process verifies that all the barcodes that are specified in the database are present in the given directory.
d) Load background form images: Load background form images by clicking on the Form images list. The images should be the blank form images on which hand snippets will be pasted to create DTD forms. Their dpi resolution should be same as of the HCDC snippets.
e) Set Output Directory: Set the path of the directory where the output DTD files will be saved.

### 6) Starting DTD Creation Process:

Once all the above is set, click the start button. The DTD creation will start, but can be paused or stopped any time during the process. There are two progress bars: the upper one shows progress of the each image, and the lower shows the progress of the whole deck. Other information, such as current process, current form, count, and time elapsed is also preferably displayed.

### 7) Field Map Creation:

On the AutoDTD application window, click on the Field Map button and dialog box as shown in FIG. 9. Set the appropriate colors for each field type or use the default. Load the DTD form encapsulated Postscript files and click the start button. Field Map files in .eps format will be created almost immediately.

While the invention has been described in connection with various embodiments, it is not intended to limit the scope of the invention to the particular form set forth. On the contrary, it is intended to cover such alternatives, modifications, and equivalents as may be included within the spirit and scope of the invention as defined by the appended claims. In particular, the test decks described herein might be electronic images of test forms or collections of handprint, machine print, or cursive image snippets in case scanner testing is not required. If printed, they could be a wide variety of printed forms, in addition to questionnaires; for example, bank checks, shipping labels, health claim forms, beneficiary forms, and other types of printed forms. Further, the forms could be semi-structured or unstructured in the sense that data might be on variable locations on various forms in the deck. This commonly occurs, for example, in the problem of automatically scanning and capturing data from such documents as invoices.

1. A method for automatically creating a test deck to qualify and test handprint recognition systems, the method comprising steps of:
(a) preparing a handprint, cursive, or machine-print snippet database containing labeled handprint image snippets;
(b) preparing a form description file and page description file to describe a form;
(c) preparing a variable database file that describes the desired content of the simulated respondent entries using the handprint character snippets;
(d) automatically populating multiple copies of the form using the variable data database in conjunction with the form description file and the handprint snippet database to create at least one of a plurality of electronic form images and a plurality of populated encapsulated postscript forms for printing a test deck.

2. The method of claim 1 including a step of creating a field map document in both encapsulated postscript and raster image format.

3. The method of claim 1 including a step of creating barcodes and their placements on the form.

4. The method of claim 1 including a step of printing the created forms of the test deck.

5. The method of claim 1 including a step of creating file containing one copy of the original form and code to put character snippets on the multiple forms to allow more efficient digital printing of the forms.

6. The method of claim 1 including a step of morphing the selected handprint characters to achieve greater variability in appearance.

7. The method of claim 1 including a step of automatically generating the content of the simulated respondent entries using dictionaries, frequency tables, or appropriate rules so the resulting content is logically consistent.

8. The method of claim 7 including a step of first generating independent field contents, and subsequently generating additional content depending upon the first generated independent contents.
